(19) United States
(12) Patent Application Publication
(10) Pub. No.: US 2008/0045623 A1
(43) Pub. Date: Feb. 21, 2008

(54) Radiation-Curable Liquid Resin Optical Fiber Upjacket Composition

(76) Inventors: Hiroshi Yamaguchi, Tokyo (JP); Satoshi Kamo, Tokyo (JP); Masanobu Sugimoto, Tokyo (JP); Takeo Shigemoto, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/663,884

(22) PCT Filed: Aug. 30, 2005
(86) PCT No.: PCT/NL05/00624

§ 371 Date: May 16, 2007

(30) Foreign Application Priority Data
Sep. 28, 2004 (JP) 2004-281023
Nov. 30, 2004 (JP) 2004-347423

(51) Int. Cl. C08G 18/67; C08F 2/46

(52) U.S. Cl. 522/83; 522/90; 522/91

(57) ABSTRACT

The present invention provides a curable liquid resin composition that when cured, exhibits excellent removability from an adjacent coating layer and low cure shrinkage rate and coefficient of linear expansion. This composition is suitable for an optical fiber upjacket material. The curable liquid resin optical fiber upjacket composition comprising a urethane (meth)acrylate, a monofunctional radiation-curable monomer, a polyfunctional radiation-curable monomer and inorganic particles or polymer particles having an average particle size of 0.1 to 100 μm.

### FIELD OF THE INVENTION

The present invention relates to a radiation-curable liquid resin optical fiber upjacket composition which is applied to and cured on the surface of a resin-coated optical fiber.

### BACKGROUND OF THE INVENTION

In the manufacture of optical fibers, a glass fiber is produced by spinning molten glass, and a resin coating is provided over the glass fiber for protection and reinforcement. This step is referred to as “fiber drawing”. As the resin coating, a structure is known in which a flexible primary coating layer is formed on the surface of the optical fiber and a rigid secondary coating layer is applied over the primary coating layer. A structure is also known in which the resin-coated optical fibers are placed side by side on a plane and bundled with a bundling material to produce a ribbon-shaped coating layer. A resin composition for forming the primary coating layer is called a primary material, a resin composition for forming the secondary coating layer is called a secondary material, and a resin composition for forming the ribbon-shaped coating layer is called a ribbon matrix material.

The outer diameter of the resin-coated optical fiber is usually about 250 μm. The outer diameter is increased to about 500 μm by applying an additional resin layer to the resin-coated optical fiber in order to improve manual workability. Such a resin coating layer is usually called an “upjacket layer”. The upjacketed optical fiber including the optical fiber upjacket layer is usually called a “resin-coated optical fiber”. Since the upjacket layer does not require optical properties, the upjacket fiber need not have transparency. The upjacket layer may be colored for identification by naked eye observation. It is important that the upjacket layer be easily removed from the resin-coated optical fiber without causing damage to the underlying primary or secondary coating layer when connecting the resin-coated optical fibers.

A curable resin used as the optical fiber coating material, including the material for the upjacket layer, is required to have superior coatability which allows high speed fiber drawing; sufficient strength and flexibility; excellent heat resistance; excellent weatherability; superior resistance to acid, alkali, and the like; excellent oil resistance; small degrees of water absorption and hygroscopicity; low hydrogen gas generation; excellent liquid storage stability; and the like.

However, since a related-art upjacket material firmly adheres to the overlying ribbon matrix material layer or underlying primary or secondary coating layer, the upjacket layer may be damaged when removing the ribbon matrix material layer to expose the upjacketed optical fiber, or the primary or secondary coating layer may be damaged when removing the upjacket layer from the upjacketed optical fiber. This hinders optical fiber connection workability.

As curable liquid resin optical fiber upjacket compositions provided with improved removability, a composition containing three types of polysiloxane compounds (patent document 1), and a composition containing organic or inorganic material particles (patent documents 2 and 3) have been disclosed.

[Patent document 1] Japanese Patent Application Laid-open No. 10-287717

[Patent document 2] Japanese Patent Application Laid-open No. 9-324136

[Patent document 3] Japanese Patent Application Laid-open No. 2000-273127

However, an upjacket layer formed by using the above-mentioned composition exhibits insufficient removability.

### SUMMARY OF THE INVENTION

An objective of the present invention is to provide a radiation-curable liquid resin optical fiber upjacket composition which exhibits an excellent function as an optical fiber coating material and, when cured, shows excellent removability from the adjacent coating layer without damaging the adjacent coating layer as well as reduction of the cure shrinkage rate and the coefficient of linear expansion of the upjacket layer.

In the present invention, various urethane (meth)acrylate-containing radiation-curable liquid resin compositions have been prepared, and the functions and removability of the resulting cured products as an optical fiber upjacket layer have been examined. As a result, the inventors have found that the above objective can be achieved by adding a monofunctional monomer, a polyfunctional monomer, particles having a particle size of 0.1 to 100 μm, and a polyol or a silicone compound having a specific molecular weight in combination to a urethane (meth)acrylate.

The present invention provides a radiation-curable liquid resin optical fiber upjacket composition, comprising:
(A) a urethane (meth)acrylate obtained by reacting a polyol, a polyisocyanate, and a hydroxyl group-containing (meth)acrylate;
(B) a monofunctional radiation-curable monomer;
(C) a polyfunctional radiation-curable monomer;
(D) 5 to 60 wt % of inorganic particles or polymer particles having an average particle size of 0.1 to 100 μm; and
(F) a photoinitiator;

wherein the weight percentage of said inorganic particles or polymer particles is 5 to 60 wt %, relative to the total weight of A, B, C and F.

The present invention also provides an optical fiber upjacket layer comprising a cured product of the curable liquid resin optical fiber upjacket composition of the invention.

The present invention further provides an upjacketed optical fiber comprising the optical fiber upjacket layer.

The present invention also relates to a process of making an optical fiber upjacket layer comprising the step of curing the liquid resin optical fiber upjacket composition.

The present invention further relates to the use of the optical fiber upjacket layer as a coating having good removability.

An optical fiber upjacket layer obtained by using the resin composition of the present invention has sufficient strength and weatherability, and maintains excellent removability even when the working conditions are changed. Therefore, optical fiber connection workability can be improved.

### DESCRIPTION OF THE INVENTION

The urethane (meth)acrylate which is the component (A) of the present invention is produced by reacting a polyol, a polyisocyanate, and a hydroxyl group-containing (meth)acrylate. Specifically, the urethane (meth)acrylate (A) is produced by reacting isocyanate groups of the polyisocyanate with a hydroxyl group of the polyol and a hydroxyl group of the hydroxyl group-containing (meth)acrylate.

This reaction is carried out by reacting the polyol, polyisocyanate, and hydroxyl group-containing (meth)acrylate all together; reacting the polyol and the polyisocyanate, and reacting the resulting product with the hydroxyl group-containing (meth)acrylate; reacting the polyisocyanate and the hydroxyl group-containing (meth)acrylate, and reacting the resulting product with the polyol; reacting the polyisocyanate and the hydroxyl group-containing (meth)acrylate, reacting the resulting product with the polyol, and further reacting the resulting product with the hydroxyl group-containing (meth)acrylate; or the like.

As examples of the polyol preferably used in this reaction, a polyether polyol, polyester polyol, polycarbonate polyol, polycaprolactone polyol, and the like can be given. There are no specific limitations to the manner of polymerization of the structural units of the polyol, which may be any of random polymerization, block polymerization, and graft polymerization. As examples of the polyether polyol, polyethylene glycol, polypropylene glycol, polytetramethylene glycol, polyhexamethylene glycol, polyheptamethylene glycol, polydecamethylene glycol, aliphatic polyether polyol obtained by ring-opening copolymerization of two or more ion-polymerizable cyclic compounds, and the like can be given. As examples of the ion-polymerizable cyclic compound, cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, glycidyl benzoate, and the like can be given. A polyether polyol obtained by ring-opening copolymerization of the ion-polymerizable cyclic compound and a cyclic imine such as ethyleneimine, cyclic lactonic acid such as α-propyolactone or glycolic acid lactide, or dimethylcyclopolysiloxane may also be used. As examples of specific combinations of the ion-polymerizable cyclic compounds, tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of the ion-polymerizable cyclic compounds may be a random copolymer or a block copolymer.

These aliphatic polyether polyols are commercially available as PTMG650, PTMG1000, PTMG2000 (manufactured by Mitsubishi Chemical Corp.), PPG400, PPG1000, PPG2000, PPG3000, Excenol 720, 1020, 2020 (manufactured by Asahi Glass Urethane Co., Ltd.), PEG1000, Unisafe DC1100, DC1800 (manufactured by Nippon Oil and Fats Co., Ltd.), PPTG2000, PPTG1000, PTG400, PTGL2000 (manufactured by Hodogaya Chemical Co., Ltd.), Z-3001-4, Z-3001-5, PBG2000A, PBG2000B (manufactured by Daiichi Kogyo Seiyaku Co., Ltd.), and the like.

Further examples of the polyether polyol include cyclic polyether polyols such as alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, alkylene oxide addition polyol of hydroquinone, alkylene oxide addition polyol of naphthohydroquinone, alkylene oxide addition polyol of anthrahydroquinone, 1,4-cyclohexane polyol and alkylene oxide addition polyol thereof, tricyclodecane polyol, tricyclodecanedimethanol, pentacyclopentadecane polyol, and pentacyclopentadecanedimethanol. Of these, alkylene oxide addition polyol of bisphenol A and tricyclodecanedimethanol are preferable. These polyols are commercially available as Uniol DA400, DA700, DA1000, DB400 (manufactured by Nippon Oil and Fats Co., Ltd.), tricyclodecanedimethanol (manufactured by Mitsubishi Chemical Corp.), and the like. Examples of other cyclic polyether polyols include alkylene oxide addition polyol of bisphenol A, alkylene oxide addition polyol of bisphenol F, alkylene oxide addition polyol of 1,4-cyclohexane polyol, and the like.

As examples of the polyester polyol, a polyester polyol obtained by reacting a dihydric alcohol and a dibasic acid and the like can be given. As examples of the dihydric alcohol, ethylene glycol, polyethylene glycol, propylene glycol, polypropylene glycol, tetramethylene glycol, polytetramethylene glycol, 1,6-hexane polyol, neopentyl glycol, 1,4-cyclohexanedimethanol, 3-methyl-1,5-pentane polyol, 1,9-nonane polyol, 2-methyl-1,8-octane polyol, and the like can be given. Examples of the dibasic acid include phthalic acid, isophthalic acid, terephthalic acid, maleic acid, fumaric acid, adipic acid, and sebacic acid, and the like. These polyester polyols are commercially available as Kurapol P-2010, PMIPA, PKA-A, PKA-A2, PNA-2000 (manufactured by Kuraray Co., Ltd.), and the like.

As examples of the polycarbonate polyol, polycarbonate of polytetrahydrofuran, polycarbonate of 1,6-hexane polyol, and the like can be given. These polycarbonate polyols are commercially available as DN-980, 981, 982, 983 (manufactured by Nippon Polyurethane Industry Co., Ltd.), PC-8000 (manufactured by PPG), PC-THF-CD (manufactured by BASF), and the like.

As examples of the polycaprolactone polyol, a polycaprolactone polyol obtained by reacting ε-caprolactone with a diol such as ethylene glycol, polyethylene glycol, propylene glycol, polypropylene glycol, tetramethylene glycol, polytetramethylene glycol, 1,2-polybutylene glycol, 1,6-hexane polyol, neopentyl glycol, 1,4-cyclohexanedimethanol, or 1,4-butane polyol, and the like can be given. These polyols are commercially available as Placcel 205, 205AL, 212, 212AL, 220, 220AL (manufactured by Daicel Chemical Industries, Ltd.), and the like.

Polyols other than those mentioned above may also be used. Given as examples of such polyols are ethylene glycol, propylene glycol, 1,4-butane polyol, 1,5-pentane polyol, 1,6-hexane polyol, neopentyl glycol, 1,4-cyclohexanedimethanol, dimethylol compound of dicyclopentadiene, tricyclodecanedimethanol, β-methyl-δ-valerolactone, hydroxy-terminated polybutadiene, hydroxy-terminated hydrogenated polybutadiene, castor oil-modified polyol, polyol-terminated compound of polydimethylsiloxane, polydimethylsiloxane carbitol-modified polyol, and the like.

A diamine may be used in combination with the polyol. As examples of the diamine, ethylenediamine, tetramethylenediamine, hexamethylenediamine, p-phenylenediamine, 4,4′-diaminodiphenylmethane, diamine containing a hetero atom, polyether diamine, and the like can be given.

Of these polyols, the polyether polyol, particularly the aliphatic polyether polyol, is preferable. Specifically, polypropylene glycol and a copolymer of butene-1-oxide and ethylene oxide are preferable. These polyols are commercially available as PPG400, PPG1000, PPG2000, PPG3000, Excenol 720, 1020, 2020 (manufactured by Asahi Glass Urethane Co., Ltd.), and the like. The copolymer diol of butene-1-oxide and ethylene oxide is commercially available as EO/BO500, EO/BO1000, EO/BO2000, EO/BO3000, EO/BO4000 (manufactured by Daiichi Kogyo Seiyaku Co., Ltd.), and the like.

A diisocyanate is preferable as the polyisocyanate. As examples of the diisocyanate, 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl isocyanate), 2,2,4-trimethylhexamethylene diisocyanate, bis(2-isocyanate ethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, 2,5(2,6)-bis(isocyanatomethyl)-bicyclo[2.2.1]heptane, and the like can be given. Of these, 2,4-tolylene diisocyanate, isophorone diisocyanate, xylylene diisocyanate, methylenebis(4-cyclohexyl isocyanate), and the like are particularly preferable.

These polyisocyanates may be used either individually or in combination of two or more.

Given as examples of the hydroxyl group-containing (meth)acrylate are 2-hydroxyethyl(meth)acrylate, 2-hydroxypropyl(meth)acrylate, 2-hydroxybutyl (meth)acrylate, 2-hydroxy-3-phenyloxypropyl(meth)acrylate, 1,4-butane polyol mono(meth)acrylate, 2-hydroxyalkyl(meth)acryloyl phosphate, 4-hydroxycyclohexyl (meth)acrylate, 1,6-hexanepolyol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates shown by the following formula (1) or (2).

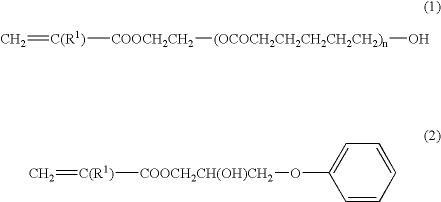

wherein R¹ represents a hydrogen atom or a methyl group, and n represents an integer from 1 to 15.

A compound obtained by the addition reaction of (meth)acrylic acid and a glycidyl group-containing compound, such as alkyl glycidyl ether, allyl glycidyl ether, or glycidyl(meth)acrylate, may also be used. Of these hydroxyl group-containing (meth)acrylates, 2-hydroxyethyl(meth)acrylate and 2-hydroxypropyl(meth)acrylate are preferable.

These hydroxyl group-containing (meth)acrylate compounds may be used either individually or in combination of two or more.

The polyol, polyisocyanate, and hydroxyl group-containing (meth)acrylate are preferably used so that the isocyanate group in the polyisocyanate and the hydroxyl group in the hydroxyl group-containing (meth)acrylate are respectively 1.1 to 3 equivalents and 0.2 to 1.5 equivalents for one equivalent of the hydroxyl group in the polyol.

In the reaction of these compounds, it is preferable to use a urethanization catalyst, such as copper naphthenate, cobalt naphthenate, zinc naphthenate, dibutyltin dilaurate, triethylamine, 1,4-diazabicyclo[2.2.2]octane, or 2,6,7-trimethyl-1,4-diazabicyclo[2.2.2]octane, in an amount of 0.01 to 1 part by weight for 100 parts by weight of the total amount of the reactants. The reaction temperature is usually 10 to 90° C., and preferably 30 to 80° C.

A part of the hydroxyl group-containing (meth)acrylate may be replaced by a compound having a functional group which can be added to an isocyanate group. As examples of such a compound, γ-mercaptotrimethoxysilane, γ-aminotrimethoxysilane, and the like can be given. Use of these compounds improves adhesion to a substrate such as glass.

A urethane (meth)acrylate obtained by reacting 1 mol of the diisocyanate with 2 mol of the hydroxyl group-containing (meth)acrylate compound may be added to the radiation-curable liquid resin composition of the present invention. Examples of such a urethane (meth)acrylate include a reaction product of hydroxyethyl(meth)acrylate and 2,4-tolylene diisocyanate, a reaction product of hydroxyethyl(meth)acrylate and 2,5(2,6)-bis(isocyanatomethyl)-bicyclo[2.2.1]heptane, a reaction product of hydroxyethyl(meth)acrylate and isophorone diisocyanate, a reaction product of hydroxypropyl(meth)acrylate and 2,4-tolylene diisocyanate, and a reaction product of hydroxypropyl(meth)acrylate and isophorone diisocyanate.

The urethane (meth)acrylate (A) is used in an amount of 30 to 90 wt %, preferably 55 to 87 wt %, and still more preferably 65 to 85 wt % of the total amount of the composition. If the amount is less than 30 wt %, the modulus of elasticity of the resulting cured product significantly varies depending on the temperature. If the amount exceeds 90 wt %, the radiation-curable liquid resin composition may have an unduly high viscosity.

In the present invention, combined use of the monofunctional curable-monomer (B) and the polyfunctional radiation-curable monomer (C) provides appropriate breaking strength necessary for removing an upjacket layer formed by using the resin composition of the present invention. When using only the monofunctional curable-monomer (B), since the elongation at break is increased, the upjacket layer must be deformed to a large extent when removing the upjacket layer. When using only the polyfunctional curable monomer (C), an increase in Young's modulus and a decrease in elongation at break occur, whereby the upjacket layer breaks when removing the upjacket layer, causing damage to the adjacent coating layer.

Examples of the monofunctional radiation-curable monomer (B) include vinyl group-containing lactams such as N-vinylpyrrolidone and N-vinylcaprolactam; alicyclic structure-containing (meth)acrylates such as isobornyl(meth)acrylate, bornyl (meth)acrylate, tricyclodecanyl(meth)acrylate, and dicyclopentanyl(meth)acrylate; benzyl(meth)acrylate, 4-butylcyclohexyl(meth)acrylate, acryloylmorpholine, vinylimidazole, vinylpyridine, and the like. Further examples include 2-hydroxyethyl (meth)acrylate, 2-hydroxypropyl(meth)acrylate, 2-hydroxybutyl(meth)acrylate, methyl (meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl (meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl (meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl (meth)acrylate, isostearyl(meth)acrylate, tetrahydrofurfuryl(meth)acrylate, butoxyethyl (meth)acrylate, ethoxydiethylene glycol (meth)acrylate, benzyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylate, N,N-dimethyl(meth)acrylamide, t-octyl(meth)acrylamide, dimethylaminoethyl (meth)acrylate, diethylaminoethyl(meth)acrylate, 7-amino-3,7-dimethyloctyl (meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and compounds shown by the following formulas (3) to (6). 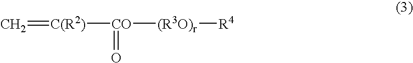
wherein R² represents a hydrogen atom or a methyl group, R³ represents an alkylene group having 2 to 6, and preferably 2 to 4 carbon atoms, R⁴ represents a hydrogen atom or an alkyl group having 1 to 12, and preferably 1 to 9 carbon atoms, and r represents an integer from 0 to 12, and preferably from 1 to 8. 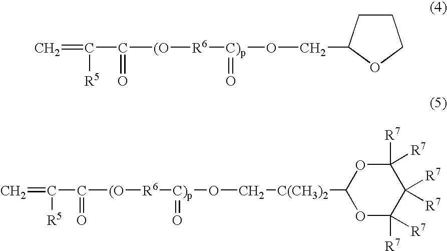
wherein R⁵ represents a hydrogen atom or a methyl group, R⁶ represents an alkylene group having 2 to 8, and preferably 2 to 5 carbon atoms, R⁷ represents a hydrogen atom or a methyl group, and p represents an integer from 1 to 4. 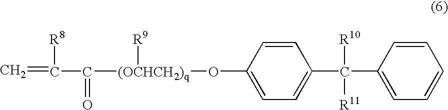
wherein R⁸, R⁹, R¹⁰, and R¹¹ individually represent a hydrogen atom or a methyl group, and q represents an integer from 1 to 5.

Of these monofunctional radiation-curable monomers, the vinyl group-containing lactams such as N-vinylpyrrolidone and N-vinylcaprolactam, isobornyl(meth)acrylate, and lauryl acrylate are preferable.

These monofunctional radiation-curable monomers are commercially available as IBXA (manufactured by Osaka Organic Chemical Industry, Ltd.), Aronix M-111, M-113, M-114, M-117, TO-1210 (manufactured by Toagosei Co., Ltd.), and the like.

The monofunctional radiation-curable monomer (B) is used in an amount of 1 to 70 wt %, preferably 1 to 50 wt %, and particularly preferably 1 to 30 wt % of the total amount of the composition from the viewpoint of viscosity of the composition.

The polyfunctional radiation-curable monomer (C) is a radiation-curable monomer having two or more polymerizable groups, such as (meth)acryloyl groups, in the molecule. Examples of the component (C) include trimethylolpropane tri(meth)acrylate, trimethylolpropanetrioxyethyl(meth)acrylate, pentaerythritol tri(meth)acrylate, triethylene glycol diacrylate, tetraethylene glycol di(meth)acrylate, tricyclodecanediyldimethylene di(meth)acrylate, 1,4-butane polyol di(meth)acrylate, 1,6-hexane polyol di(meth)acrylate, neopentyl glycol di(meth)acrylate, tripropylene glycol di(meth)acrylate, neopentyl glycol di(meth)acrylate, (meth)acrylic acid-terminated (both terminals) addition product of bisphenol A diglycidyl ether, pentaerythritol tri(meth)acrylate, pentaerythritol tetra(meth)acrylate, polyester di(meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, di(meth)acrylate of ethylene oxide or propylene oxide addition bisphenol A, di(meth)acrylate of ethylene oxide or propylene oxide addition hydrogenated bisphenol A, epoxy(meth)acrylate prepared by addition of (meth)acrylate to diglycidyl ether of bisphenol A, triethylene glycol divinyl ether, compounds shown by the following formula (7), and the like.
CH₂═C(R²)—COO—(CH₂—CH(R¹³)—O)ₙ—CO—C(R¹²)═CH₂ (7)
wherein R¹² and R¹³ individually represent a hydrogen atom or a methyl group, and n represents an integer from 1 to 100.

Of these polyfunctional radiation-curable monomers, the compounds shown by the formula (7), such as ethylene glycol di(meth)acrylate, polyethylene glycol di(meth)acrylate, tricyclodecanediyldimethylene di(meth)acrylate, di(meth)acrylate of ethylene oxide addition bisphenol A, and tris(2-hydroxyethyl)isocyanurate tri(meth)acrylate, are preferable.

These polyfunctional radiation-curable compounds are commercially available as Yupimer UV, SA1002 (manufactured by Mitsubishi Chemical Corp.), Aronix M-215, M-315, M-325, TO-1210 (manufactured by Toagosei Co., Ltd.), and the like.

The polyfunctional radiation-curable monomer (C) is used in an amount of 1 to 60 wt %, preferably 1 to 40 wt %, and particularly preferably 1 to 30 wt % of the total amount of the composition from the viewpoint of viscosity of the composition and Young's modulus and elongation of the cured product.

In the present invention, the removability of the upjacket layer formed by using the resin composition of the present invention is improved by adding inorganic particles or polymer particles having an average particle size of 0.1 to 100 μm as the component (D) to the composition. Moreover, stable removability can be obtained even when the working conditions are changed. Specifically, the cure shrinkage rate and the coefficient of linear expansion of the upjacket layer are reduced when the particles as component (D) are added. A decrease in the cure shrinkage rate causes a decrease in the tightening force of the upjacket layer caused by cure shrinkage when manufacturing an upjacketed optical fiber, whereby the adhesion between the upjacket layer and the lower layer can be easily adjusted to a value equal to or less than a predetermined value. This ensures stable removability.

Moreover, a decrease in the coefficient of linear expansion reduces the temperature dependence of the tightening force of the upjacket layer, whereby a change in the adhesion between the upjacket layer and the lower layer accompanying a change in temperature is reduced. This reduces the temperature dependence of the removability. Furthermore, since the component (D) shows a small change in shape under various conditions (e.g. 85° C./85%, 80° C./dry, 120° C./dry, and 80° C./warm water), a change in volume of the upjacket layer under these conditions is reduced. This ensures stable removability under various working conditions.

The average particle size of the component (D) is preferably 0.1 to 100 μm, and still more preferably 0.5 to 100 μm. If the average particle size is less than 0.1 μm, the particle size of the composition is increased to a large extent, and the removability improvement effect becomes insufficient. If the average particle size exceeds 100 μm, transmission loss of the upjacketed optical fiber is increased.

As examples of the inorganic particles used as the components (D), particles containing calcium carbonate, calcium silicate, calcium sulfate, kaolin, talc, silica, mica, magnesium carbonate, magnesium oxide, magnesium hydroxide, basic magnesium carbonate, hydrotalcite, alumina, barium sulfate, barium carbonate, barium titanate, potassium titanate, titanium oxide, zinc oxide, cerium oxide, zirconium oxide, zircon silicate, silicon nitride, silicon carbide, aluminum borate, aluminum hydroxide, bentonite, zeolite, antimony trioxide, antimony pentoxide, glass beads, carbon fiber, or the like as the major component can be given. Of these, particles containing calcium carbonate or aluminum hydroxide as the major component are more preferable. The surface of the inorganic particle may be modified with a silicone resin, a silane coupling agent, a phosphorus coupling agent, or the like.

As examples of the polymer particles, particles containing a polyolefin, acrylic resin, polyurethane, polyamide, polystyrene, silicone resin, styrene-divinylbenzene copolymer, or the like as the major component can be given. These polymer particles may be crosslinked polymer particles or uncrosslinked polymer particles. It is still more preferable to use particles containing a styrene-divinylbenzene copolymer or acrylic resin as the major component.

The inorganic particles or the polymer particles used as the component (D) are commercially available as C302A (aluminum hydroxide; particle size: 1.14 μm, 2.0 μm, or 5.0 μm; manufactured by Sumitomo Chemical Co., Ltd.), H42-S (aluminum hydroxide surface-treated with stearic acid; particle size: 1.2 μm; manufactured by Showa Denko K.K.), H42-STV (aluminum hydroxide surface-treated with vinylsilane; particle size: 1.1 μm; manufactured by Showa Denko K.K.), UD-650 (magnesium hydroxide; particle size: 3.26 μm; manufactured by Ube Materials Corporation), UD-653 (magnesium hydroxide surface-treated with fatty acid; particle size: 3.02 μm; manufactured by Ube Materials Corporation), magnesium hydroxide surface-treated with fatty acid (particle size: 1.0 μm; manufactured by Kyowa Hakko Kogyo Co., Ltd.), KISUMA-5P (magnesium hydroxide surface-treated with vinylsilane; particle size: 0.89 gμm; manufactured by Kyowa Chemical Industry Co., Ltd.), KISUMA-5L (magnesium hydroxide surface-treated with vinylsilane; particle size: 0.89 μm; manufactured by Kyowa Chemical Industry Co., Ltd.), KISUMA-5A (magnesium hydroxide surface-treated with fatty acid; particle size: 0.82 μm; manufactured by Kyowa Chemical Industry Co., Ltd.), KISUMA-5B (magnesium hydroxide surface-treated with fatty acid; particle size: 0.87 μm; manufactured by Kyowa Chemical Industry Co., Ltd.), Calseeds P (calcium carbonate surface-treated with fatty acid; particle size: 0.15 μm; manufactured by Konoshima Chemical Industry Co., Ltd.), and the like.

Of these inorganic particles and polymer particles, it is preferable to use the inorganic particles in view of providing applicability (versatility) and flame resistance. In particular, it is preferable to use surface-treated particles containing calcium carbonate or aluminum hydroxide as the major component.

The inorganic particles and polymer particles used as the component (D) are used in an amount of preferably 5 to 60 wt % of the upjacket composition, and still more preferably 15 to 50 wt %, relative to the total weight of A, B, C and F, in order to ensure the removability improvement effect and maintaining characteristics as an upjacket material.

The curable liquid resin composition of the present invention further includes (E1) a polyol having an average molecular weight of 1000 or more or (E2) a silicone compound having an average molecular weight of 1000 or more, as a component (E). The component (E) is important for improving removability of an optical fiber upjacket layer formed by using the resin composition of the present invention from an adjacent layer. The average molecular weight used herein refers to the polystyrene-reduced number average molecular weight determined by gel permeation chromatography.

If the molecular weight of the polyol (E1) is less than 1000, durability may be decreased due to a problem relating to a transfer to an ink layer. The molecular weight of the polyol compound is preferably 1000 to 10000, and still more preferably 1000 to 8000.

As examples of the polyol (E1), a polyether polyol, polyester polyol, polycarbonate polyol, polycaprolactone polyol, and the like can be given. There are no specific limitations to the manner of polymerization of the structural units of the polyol, which may be any of random polymerization, block polymerization, and graft polymerization.

Of these, a polyether polyol having a molecular weight of 1000 or more is preferable. As examples of the polyether polyol, polyethylene glycol, polypropylene glycol, polytetramethylene glycol, polyhexamethylene glycol, polyheptamethylene glycol, polydecamethylene glycol, aliphatic polyether polyol obtained by ring-opening copolymerization of two or more ion-polymerizable cyclic compounds, and the like can be given. As examples of the ion-polymerizable cyclic compound, cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, glycidyl benzoate, and the like can be given. A polyether polyol obtained by ring-opening copolymerization of the ion-polymerizable cyclic compound with a cyclic imine such as ethyleneimine, cyclic lactone acid such as β-propyolactone or glycolic acid lactide, or dimethylcyclopolysiloxane may also be used. As examples of specific combinations of the ion-polymerizable cyclic compounds, tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide, and the like can be given. The ring-opening copolymer of the ion-polymerizable cyclic compounds may be a random copolymer or a block copolymer.

These aliphatic polyether polyols are commercially available as PTMG2000 (manufactured by Mitsubishi Chemical Corp.), PPG2000, PPG3000, Excenol 2020 (manufactured by Asahi Glass Urethane Co., Ltd.), DC1800 (manufactured by Nippon Oil and Fats Co., Ltd.), PPTG2000, PTGL2000 (manufactured by Hodogaya Chemical Co., Ltd.), PBG2000A, PBG2000B (manufactured by Daiichi Kogyo Seiyaku Co., Ltd.), and the like.

Further examples of the polyether polyol include cyclic polyether polyols such as an alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, alkylene oxide addition polyol of hydroquinone, alkylene oxide addition polyol of naphthohydroquinone, alkylene oxide addition polyol of anthrahydroquinone, 1,4-cyclohexane polyol and alkylene oxide addition polyol thereof, tricyclodecane polyol, tricyclodecanedimethanol, pentacyclopentadecane polyol, and pentacyclopentadecanedimethanol. Examples of other cyclic polyether polyols include an alkylene oxide addition polyol of bisphenol A, alkylene oxide addition polyol of bisphenol F, alkylene oxide addition polyol of 1,4-cyclohexane polyol, and the like. The polyol may have only a linear molecule or may have a branched structure. The polyol may have a linear molecule and a branched structure in combination.

Of these polyols, it is preferable to use a polyol having a branched structure such as an alkyl group (e.g. methyl group or ethyl group), in which a hydroxyl group is bonded to the terminal of each branched chain, and having a value obtained by dividing the molecular weight of the polyol by the number of hydroxyl groups at the branched chain terminals of 500 to 2,000 (hereinafter also referred to as “branched structure-containing polyol”).

As specific examples of the branched structure-containing polyol, a polyol obtained by ring-opening polymerization of glycerol or sorbitol and at least one compound selected from ethylene oxide, propylene oxide, and butylene oxide is preferable. In particular, polypropylene glycol and a copolymer of butane-1-oxide and ethylene oxide are preferable.

The value obtained by dividing the molecular weight of the polyol by the number of the hydroxyl groups at the branched chain terminals is preferably 500 to 2000, and more preferably 1000 to 1500. The number average molecular weight of the polyol is preferably 1000 to 12000, more preferably 2000 to 10000, and particularly preferably 2500 to 8000 as the polystyrene-reduced molecular weight determined by gel permeation chromatography.

The branched structure-containing polyol preferably contains 3 to 6 branched chain terminal hydroxyl groups in one molecule.

The above polyol is commercially available as PPG2000, PPG3000, Excenol 2020 (manufactured by Asahi Glass Urethane Co., Ltd.), and the like. The copolymer diol of butene-1-oxide and ethylene oxide is commercially available as EO/BO2000, EO/BO3000, EO/BO4000 (manufactured by Daiichi Kogyo Seiyaku Co., Ltd.) and the like.

The branched structure-containing polyol is commercially available as Sannix TP-400, Sannix GL-3000, Sannix GP-250, Sannix GP-400, Sannix GP-600, Sannix GP-1000, Sannix GP-3000, Sannix GP-3700M, Sannix GP-4000, Sannix GEP-2800, Newpol TL4500N (manufactured by Sanyo Chemical Industries, Ltd), and the like.

The component (E1) is used in an amount of preferably 0.1 to 50 wt %, more preferably 0.5 to 40 wt %, still more preferably 1 to 30 wt %, and particularly preferably 1 to 20 wt % of 100 wt % of the total amount of the components (A), (B), (C) and (F), in order to ensure removability, strength, and weatherability of the resulting upjacket layer.

The curable liquid resin composition of the present invention further includes a silicone compound having a molecular weight of 1000 or more as the component (E2). The component (E) is important for improving removability of an optical fiber upjacket layer formed by using the resin composition of the present invention from the adjacent layer. The average molecular weight of the component (E) is preferably 1000 to 30000. If the number average molecular weight is less than 1000, a sufficient removability improvement effect cannot be obtained. If the average molecular weight exceeds 30000, the removability improvement effect is decreased. The average molecular weight is still more preferably 1000 to 20000, and particularly preferably 3000 to 15000.

As examples of the silicone compound, polyether-modified silicone, allyl-modified silicone, urethane acrylate-modified silicone, urethane-modified silicone, methylstyryl-modified silicone, epoxy polyether-modified silicone, alkylaralkyl polyether-modified silicone, and the like can be given. Of these, the polyether-modified silicone is preferable. As the polyether-modified silicone, a polydimethylsiloxane compound in which a group represented by R¹⁴—(R¹⁵O)ₛ—R¹⁶— (wherein R¹⁴ represents a hydroxyl group or an alkoxy group having 1 to 10 carbon atoms, R¹⁵ represents an alkylene group having 2 to 4 carbon atoms (R¹⁵ may contain two or more types of alkylene groups), R¹⁶ represents an alkylene group having 2 to 12 carbon atoms, and s represents an integer from 1 to 20) is bonded to at least one silicon atom is preferable. As the alkylene group represented by R¹⁵, an ethylene group or a propylene group is preferable, with the ethylene group being particularly preferable. The silicone compound is commercially available as SH28PA: dimethylpolysiloxane-polyoxyalkylene copolymer (manufactured by Dow Corning Toray Co., Ltd.), FM0411: dimethylpolysiloxane-polyoxyalkylene copolymer (manufactured by Chisso Corp.), Silaplane (manufactured by Chisso Corp.), dimethylpolysiloxane-polyoxyalkylene copolymer (containing side-chain OH) (manufactured by Dow Corning Toray Co., Ltd.), Bykuv 3510: dimethylpolysiloxane-polyoxyalkylene copolymer (manufactured by BYK-Chemie Japan), DC57: dimethylpolysiloxane-polyoxyalkylene copolymer (manufactured by Dow Corning Toray Co., Ltd.), and the like.

The polyol or the silicone compound having a molecular weight of 1000 or more used as the component (E) may contain a (meth)acryloyl group. The component (E) having such a structure may be obtained by reacting the hydroxyl group of the polyol (E1) or the silicone compound (E2) with the hydroxyl group-containing (meth)acrylate via the isocyanate.

The component (E) is used in an amount of preferably 0.1 to 50 wt %, more preferably 1 to 50 wt %, still more preferably 0.5 to 40 wt %, and particularly preferably 1 to 20 wt % for 100 wt % of the total amount of the components (A), (B), (C) and (F) in order to ensure removability, strength, and weatherability of the resulting upjacket layer.

A photoinitiator (F) is used in the resin composition of the present invention. It is preferable to use a photosensitizer in combination with the photoinitiator, as required. Given as examples of the photoinitiator are 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl methyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide; Irgacure 184, 369, 651, 500, 907, CGI 1700, CGI 1750, CGI 1850, CG24-61, Darocure 1116, 1173 (manufactured by Ciba Specialty Chemicals Co.); Lucirin TPO (manufactured by BASF); and Ubecryl P36 (manufactured by UCB). As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate; Ubecryl P102, 103, 104, 105 (manufactured by UCB); and the like can be given.

If both ultraviolet rays and heat are used to cure the resin composition of the present invention, a heat polymerization initiator such as a peroxide or an azo compound and the photoinitiator may be used in combination. The photoinitiator (F) is used in an amount of preferably 0.1 to 10 wt %, and particularly preferably 0.3 to 7 wt % of the total amount of the composition.

A flame retardant (G) may be added to the resin composition of the present invention. There are no specific limitations to the flame retardant (G). Examples of the flame retardant (G) include a halogen-based (bromine-based or chlorine-based) flame retardant, phosphorus-based flame retardant, nitrogen-based flame retardant and silicone-based flame retardant.

Examples of the bromine-containing flame retardant include tetrabromobisphenol A (TBBPA), decabromodiphenyl oxide, hexabromocyclododecane, tribromophenol, ethylenebistetrabromophthalimide, TBBPA polycarbonate oligomer, brominated polystyrene, TBBPA epoxy oligomer, TBBPA bisbromopropyl ether, ethylenebispentabromodiphenol, pentabromobenzylacrylate, hexabromobenzene, brominated aromatic triazine, and the like.

As examples of the phosphorus-based flame retardant, a phosphate, halogen-containing phosphate, ammonium polyphosphate, red phosphorus compound, phosphaphenanthrene, and the like can be given.

As examples of the chlorine-based flame retardant, a chlorinated paraffin, perchlorocyclopentadecane, chlorendic acid, and the like can be given.

The flame retardant (G) is used in an amount of preferably 1.0 to 50 parts by weight, and particularly preferably 1 to 20 parts by weight for 100 parts by weight of the total amount of the components (A) to (E). If the amount is less than 1.0 part by weight, the flame retarding effect may be insufficient. If the amount exceeds 50 parts by weight, the flame retardant may bleed out from the resulting cured product, or the elastic properties of the resulting upjacket layer may be adversely affected.

Additives such as antioxidants, coloring agents, UV absorbers, light stabilizers, silane coupling agents, heat polymerization inhibitors, leveling agents, surfactants, preservatives, plasticizers, lubricants, solvents, aging preventives, wettability improvers, and coating surface improvers may optionally be added to the composition of the present invention.

The curable liquid resin composition of the present invention is cured by applying heat and/or radiation. Radiation used herein includes infrared rays, visible rays, ultraviolet rays, X-rays, electron beams, α-rays, β-rays, γ-rays, and the like.

The Young's modulus of the cured product of the resin composition of the present invention is preferably about 100 MPa to about 600 MPa, it can also have a value of about 200 to about 500 MPa. The resin composition of the present invention is preferably applied to a thickness of 100 to 350 μm when forming an upjacket layer.

### EXAMPLES

The present invention is described below in detail by way of examples, which should not be construed as limiting the present invention.

### Synthesis Example 1

### Urethane Acrylate Oligomer: Used in Examples 1 to 8

A reaction vessel equipped with a stirrer was charged with 15.381 g of tetraethylene nonyl phenyl ether acrylate, 0.015 g of 2,6-di-t-butyl-p-cresol, 7.80 g of toluene diisocyanate, and 0.023 g of dibutyltin dilaurate. The mixture was cooled with ice to 15 to 20° C. with stirring. After the addition of 6.00 g of hydroxyethyl acrylate, the mixture was allowed to react at 35° C. or less for two hours with stirring. After the addition of 28.341 g of polytetramethylene glycol with a number average molecular weight of 2000 (PTMG2000; manufactured by Mitsubishi Chemical Corp.), 1.790 g of polyethylene glycol bisphenol A ether with a number average molecular weight of 400 (Uniol DA400; manufactured by Nippon Oil and Fats Co., Ltd.), and 0.022 g of dibutyltin dilaurate, the mixture was stirred at room temperature for one hour. The mixture was then stirred at 65° C. for two hours in an oil bath. The reaction was terminated when the residual isocyanate content became 0.1 wt % or less. The resulting product was a mixed solution of three types of urethane (meth)acrylate oligomers (A), including a urethane acrylate oligomer (A-1) in which hydroxyethyl acrylate bonded to the terminal hydroxyl groups of polyethylene glycol bisphenol A ether via toluene diisocyanate, a urethane (meth)acrylate oligomer (A-2) in which hydroxyethyl acrylate bonded to the terminal hydroxyl groups of polytetramethylene glycol via toluene diisocyanate, and a urethane (meth)acrylate oligomer (A-3) in which hydroxyethyl acrylate bonded to two isocyanate groups of toluene diisocyanate.

### Synthesis Example 2

### Urethane Acrylate Oligomer: Used in Examples 9 to 19

A reaction vessel equipped with a stirrer was charged with 87.93 g of isobornyl acrylate, 0.124 g of 2,6-di-t-butyl-p-cresol, 131.77 g of toluene diisocyanate, and 0.212 g of dibutyltin dilaurate. The mixture was cooled with ice to 15 to 20° C. with stirring. After the slow dropwise addition of 114.02 g of hydroxyethyl acrylate, the mixture was allowed to react at 35° C. or less for two hours with stirring. After the addition of 199.37 g of polytetramethylene glycol with a number average molecular weight of 2000, 69.78 g of polyethylene bisphenol A ether with a number average molecular weight of 400, and 0.200 g of dibutyltin dilaurate, the mixture was stirred at room temperature for one hour. The mixture was then stirred at 65° C. for two hours in an oil bath. The reaction was terminated when the residual isocyanate content became 0.1 wt % or less. The resulting product was a mixed solution of three types of urethane (meth)acrylate oligomers (A-1, A-2, and A-3) similar to those obtained in Synthesis Example 1.

### Synthesis Example 3

### Preparation of Polyol (E1) Containing (meth)acryloyl Group

A reaction vessel equipped with a stirrer was charged with 0.184 g of 2,6-di-t-butyl-p-cresol, 31.20 g of toluene diisocyanate, and 0.615 g of dibutyltin dilaurate. The mixture was cooled with ice to 15° C. or lower with stirring. 20.80 g of 2-hydroxyethyl acrylate was slowly added dropwise to the mixture while maintaining the solution temperature at 25° C. or lower. Then, the mixture was stirred at 20° C. for two hours. After the addition of 716.57 g of a polypropylene oxide ring-opening polymer having a number average molecular weight of 10000, the mixture was allowed to react at 50° C. for two hours with stirring. The reaction was terminated when the residual isocyanate content became 0.1 wt % or less. The resulting mixture was further stirred at 50° C. for one hour to obtain a target urethane acrylate containing one (meth)acryloyl group. The component (E1) thus obtained is called “E1-2”.

### Synthesis Example 4

### Preparation of Silicone Compound (E2) Containing (meth)acryloyl Group

A reaction vessel equipped with a stirrer was charged with 0.024 g of 2,6-di-t-butyl-p-cresol, 79.911 g of FM0411 (dimethylpolysiloxane-polyoxyethylene copolymer (molecular weight: 1170); manufactured by Chisso Corp.), 11.986 g of toluene diisocyanate, and 0.08 g of dibutyltin dilaurate. The mixture was cooled with ice to 15° C. or lower with stirring. 7.991 g of 2-hydroxyethyl(meth)acrylate was slowly added dropwise to the mixture at 25° C. or lower. Then, the mixture was stirred at 20° C. for two hours. The resulting mixture was allowed to react at 50° C. for two hours with stirring. The reaction was terminated when the residual isocyanate content became 0.1 wt % or less. The target urethane acrylate containing one (meth)acryloyl group was thus obtained. The component (E2) thus obtained is called “E2-2”.

### Examples 1 to 19 and Comparative Examples 1 to 3

A reaction vessel was charged with components and particles shown in Table 1. The mixture was stirred at 60° C. for two hours to obtain a radiation-curable liquid resin composition.

### Test Example 1

The resin compositions obtained in the examples and comparative examples were cured according to the following method to prepare specimens. The test specimens were subjected to the following evaluation:

1. Preparation of Specimen

Preparation of Test Film: the Curable Liquid Resin Composition was Applied to a glass plate using an applicator bar with a gap size of 250 μm. The applied composition was cured by applying ultraviolet rays at a dose of 1 J/cm² in air to obtain a test film.

2. Cure Shrinkage Rate

A specific gravity bottle which had been washed and dried was filled with liquid Desolite so that bubbles were not formed. The specific gravity bottle was capped and allowed to stand in a thermostat at 25° C. for 30 minutes. The lid of the specific gravity bottle was pressed downward, and the Desolite overflowing from the specific gravity bottle was wiped off and subjected to mass measurement. The density and the specific gravity were calculated based on the weight of the specific gravity bottle.

The film formed as described above was cut into a piece having a size of about 20×20 mm and subjected to mass measurement. After filling a beaker with about 180 mL of distilled water at 25° C., the mass of the beaker was measured in a state in which a wire was suspended and immersed in the distilled water in the beaker. The mass of the beaker was also measured in a state in which the wire provided with the specimen was fully immersed in the distilled water. The cure shrinkage rate was calculated from the density and the specific gravity in a liquid state and the density and the specific gravity of the film.

The composition of the present invention, when cured, has a cure shrinkage rate of no more than 5.5%, preferably no more than 5.3%, more preferably no more than 5%.

3. Coefficient of Linear Expansion

The cured film obtained above was cut into a strip of 3×30 mm, and attached to a pulling mode probe at a chuck distance of 20 mm and a sample width of 3 mm. The coefficient of linear expansion was measured at a load of 1 g by using a coefficient of thermal expansion measurement device (TMA: manufactured by Seiko Instruments Inc.).

The composition of the present invention, when cured, has a coefficient of linear expansion of no more than 1.3, preferably no more than 1.2.

### Test Example 2

Upjacket layers were formed by using the resin compositions obtained in the examples and comparative examples, and the removability of the upjacket layers was evaluated.

(1) Preparation of Upjacket Layer

A primary material (R1164: manufactured by JSR Corporation), a secondary material (R3180: manufactured by JSR Corporation), and an ink material (FS blue ink: T&K TOKA) were applied in tandem in that order to a glass fiber (synthetic quartz rod: manufactured by TSL Co., Ltd.) and cured by applying ultraviolet rays using a rewinder model (manufactured by Yoshida Kogyo Co., Ltd.) to obtain a resin-coated optical fiber having an outer diameter of 250 μm. The curable composition shown in Table 1 was applied to the resin-coated optical fiber as an upjacket material, and cured by applying ultraviolet rays using the rewinder model to obtain an upjacketed optical fiber having an outer diameter of 500 μm. The resulting upjacketed optical fiber was used as the measurement sample.

(2) Removal Stress

A primary material (R1164: manufactured by JSR Corporation), a secondary material (R3180: manufactured by JSR Corporation), and an ink material (FS blue ink: T&K TOKA) were applied to a glass fiber and cured by applying ultraviolet rays using a rewinder model (manufactured by Yoshida Kogyo Co., Ltd.) to obtain a resin-coated optical fiber having an outer diameter of 250 μm. The curable composition shown in Table 1 was applied to the resin-coated optical fiber as an upjacket material, and cured by applying ultraviolet rays using the above rewinder model to obtain an upjacketed optical fiber having an outer diameter of 500 μm. The resulting upjacketed optical fiber was used as the measurement sample.

As shown in FIG. 1, the upjacketed optical fiber was held by using a hot stripper (manufactured by Furukawa Electric Co., Ltd.) at a position 3 cm from the end. The upjacketed optical fiber was then pulled at a tensile rate of 50 m/min by using a tensile tester (manufactured by Shimadzu Corp.) to measure the coating removal stress (maximum stress shown in FIG. 2) when removing the upjacket layer. The measurement temperature was 23° C. and −20° C. The measurement was carried out immediately after producing the upjacketed optical fiber thereinafter referred to as “coating removal stress immediately after production”). The measurement was also carried out after allowing the upjacketed optical fiber to stand at a temperature of 85° C. and a relative humidity of 85% for seven days (hereinafter referred to as “coating removal stress after high-temperature and high-humidity test”).

The results are shown in Table 1. The amount of each components shown in Table 1 is indicated in parts by weight.

TABLE 1

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| (A) | A-1 | 5.0 | 5.0 | 5.0 | 5.0 | 5.0 | 5.0 | 5.0 | 5.0 | 6.0 | 6.0 | 6.0 | 6.0 |
| | A-2 | 41.6 | 41.6 | 41.6 | 41.6 | 41.6 | 41.6 | 41.6 | 41.6 | 49.9 | 49.9 | 49.9 | 49.9 |
| | A-3 | 3.4 | 3.4 | 3.4 | 3.4 | 3.4 | 3.4 | 3.4 | 3.4 | 4.1 | 4.1 | 4.1 | 4.1 |
| (B) | N-Vinyl-2-pyrrolidone | 6.0 | 6.0 | 6.0 | 6.0 | 6.0 | 6.0 | 6.0 | 6.0 | | | | |
| | Polyoxyethylene nonyl | 12.0 | 12.0 | 12.0 | 12.0 | 12.0 | 12.0 | 12.0 | 12.0 | | | | |
| | phenyl ether acrylate | | | | | | | | | | | | |
| | Isobornyl acrylate | | | | | | | | | 16.0 | 16.0 | 16.0 | 16.0 |
| | N-vinylcaprolactam | | | | | | | | | 8.0 | 8.0 | 8.0 | 8.0 |
| (C) | Tricyclodecanedimethylol | 4.0 | 4.0 | 4.0 | 4.0 | 4.0 | 4.0 | 4.0 | 4.0 | 12.0 | 12.0 | 12.0 | 12.0 |
| | diacrylate | | | | | | | | | | | | |
| | Trimethylolpropane ethoxy | 25.0 | 25.0 | 25.0 | 25.0 | 25.0 | 25.0 | 25.0 | 25.0 | 0.0 | 0.0 | 0.0 | 0.0 |
| | triacrylate | | | | | | | | | | | | |
| | Irgacure 184 | 1.0 | 1.0 | 1.0 | 1.0 | 1.0 | 1.0 | 1.0 | 1.0 | 3.0 | 3.0 | 3.0 | 3.0 |
| | Lucirin TPO | 1.5 | 1.5 | 1.5 | 1.5 | 0.0 | 1.5 | 1.5 | 1.5 | 0.5 | 0.5 | 0.5 | 0.5 |
| | Irgacure 819 | | | | | 1.5 | | | | | | | |
| | Irganox 1035 | 0.5 | 0.5 | 0.5 | 0.5 | 0.5 | 0.5 | 0.5 | 0.5 | 0.5 | 0.5 | 0.5 | 0.5 |
| (E) | E1-1 | | | | | | | | | | | | |
| | E1-2 | 10.0 | 10.0 | 10.0 | 10.0 | 10.0 | 10.0 | 10.0 | 10.0 | 10.0 | | | |
| | E2-1 | 10.0 | 10.0 | 10.0 | 10.0 | 10.0 | 10.0 | 10.0 | 10.0 | 10.0 | | | |
| | E2-2 | | | | | | | | | | | 10.0 | |
| (D) | Particle 1 | 10.0 | 40.0 | 80.0 | 100.0 | | | | | | 40.0 | 40.0 | 40.0 |
| | Particle 2 | | | | | 40.0 | 40.0 | | | 40.0 | | | |
| | Particle 3 | | | | | | | 40.0 | | | | | |
| | Particle 4 | | | | | | | | 40.0 | | | | |
| | Particle 5 | | | | | | | | | | | | |
| | Particle 6 | | | | | | | | | | | | |
| | Particle 7 | | | | | | | | | | | | |
| | Particle 8 | | | | | | | | | | | | |
| | Curability | | | | | | | | | | | | |
| | Cure shrinkage rate (%) | 4.8 | 3.6 | 2.2 | 1.5 | 3.5 | 3.5 | 3.3 | 3.5 | 3.0 | 3.6 | 3.7 | 3.6 |
| | Coefficient of linear | 1.2 | 0.8 | 0.6 | 0.5 | 0.9 | 0.9 | 0.8 | 0.9 | 0.7 | 0.8 | 0.8 | 0.9 |
| | expansion (×10−4/o C., −50−50o C.) | | | | | | | | | | | | |
| | Upjacketed optical fiber | | | | | | | | | | | | |
| | Coating removal stress (N) | 3.1 | 2.8 | 2.4 | 2.2 | 2.5 | 2.6 | 2.6 | 2.7 | 2.9 | 4.1 | 3.9 | 3.1 |
| | immediately after production @23° C. | | | | | | | | | | | | |
| | Coating removal stress (N) | 3.3 | 2.9 | 2.6 | 2.3 | 2.6 | 2.8 | 2.7 | 2.9 | 3.0 | 4.3 | 4.1 | 3.4 |
| | immediately after production @−20° C. | | | | | | | | | | | | |
| | Coating removal stress (N) | 3.3 | 2.9 | 2.5 | 2.3 | 2.7 | 2.8 | 2.7 | 2.9 | 3.2 | 4.4 | 4.2 | 3.5 |
| | after high-temperature and | | | | | | | | | | | | |
| | high-humidity test @23° C. | | | | | | | | | | | | |

| | | Example | | | | | | Comparative Example | | |
|---|---|---|---|---|---|---|---|---|---|---|
| | | 13 | 14 | 15 | 16 | 18 | 19 | 1 | 2 | 3 |
| (A) | A-1 | 6.0 | 6.0 | 6.0 | 6.0 | 2.6 | 2.6 | 5.0 | 6.0 | 6.0 |
| | A-2 | 49.9 | 49.9 | 49.9 | 49.9 | 22.0 | 22.0 | 41.6 | 49.9 | 49.9 |
| | A-3 | 4.1 | 4.1 | 4.1 | 4.1 | 1.8 | 1.8 | 3.4 | 4.1 | 4.1 |
| (B) | N-Vinyl-2-pyrrolidone | 6.0 | 6.0 | 6.0 | | 3.5 | 3.5 | 6.0 | | |
| | Polyoxyethylene nonyl | 12.0 | 12.0 | 12.0 | | 9.2 | 9.2 | 12.0 | | |
| | phenyl ether acrylate | | | | | | | | | |
| | Isobornyl acrylate | | | | 16.0 | | | | 16.0 | 16.0 |
| | N-vinylcaprolactam | | | | 8.0 | | | | 8.0 | 8.0 |
| (C) | Tricyclodecanedimethylol | 4.0 | 4.0 | 4.0 | 12.0 | 1.4 | 1.4 | 4.0 | 12.0 | 12.0 |
| | diacrylate | | | | | | | | | |
| | Trimethylolpropane ethoxy | 25.0 | 25.0 | 25.0 | 0.0 | 17.3 | 17.3 | 25.0 | | |
| | triacrylate | | | | | | | | | |
| | Irgacure 184 | 1.0 | 1.0 | 1.0 | 3.0 | 1.8 | | 1.0 | 3.0 | 3.0 |
| | Lucirin TPO | 1.5 | 1.5 | 1.5 | 0.5 | | | 1.5 | 0.5 | 0.5 |
| | Irgacure 819 | | | | | | | | | |
| | Irganox 1035 | 0.5 | 0.5 | 0.5 | 0.5 | 0.2 | 0.2 | 0.5 | 0.5 | 0.5 |
| (E) | E1-1 | | | | | 10.0 | 10.0 | | | |
| | E1-2 | 10.0 | 10.0 | 10.0 | 10.0 | | | 10.0 | 10.0 | |
| | E2-1 | 10.0 | 10.0 | 10.0 | 10.0 | 4.0 | 4.0 | 10.0 | 10.0 | |
| | E2-2 | | | | | | | | | |
| (D) | Particle 1 | | | | | | | | | |
| | Particle 2 | | | | | | 25.0 | | | |
| | Particle 3 | | | | | | | | | |
| | Particle 4 | | | | | | | | | |
| | Particle 5 | 40.0 | | | | | | | | |
| | Particle 6 | | 40.0 | | | | | | | |
| | Particle 7 | | | 40.0 | | 25.0 | | | | |
| | Particle 8 | | | | 40.0 | | | | | |
| | Curability | | | | | | | | | |
| | Cure shrinkage rate (%) | 3.5 | 3.3 | 3.5 | 3.0 | 3.0 | 3.0 | 5.8 | 5.6 | 6.1 |
| | Coefficient of linear | 0.9 | 0.8 | 0.9 | 0.7 | 0.9 | 0.7 | 1.6 | 1.4 | 1.4 |
| | expansion (×10−4/o C., −50−50o C.) | | | | | | | | | |
| | Upjacketed optical fiber | | | | | | | | | |
| | Coating removal stress (N) | 2.6 | 2.6 | 2.7 | 2.9 | 2.9 | 2.9 | 3.0 | 3.9 | 6.1 |
| | immediately after production @23° C. | | | | | | | | | |
| | Coating removal stress (N) | 2.8 | 2.7 | 2.9 | 3.0 | 3.0 | 3.0 | 7.2 | NA* | 6.5 |
| | immediately after production @−20° C. | | | | | | | | | |
| | Coating removal stress (N) | 2.8 | 2.7 | 2.9 | 2.9 | 3.1 | 3.1 | 3.5 | 4.8 | 6.6 |
| | after high-temperature and | | | | | | | | | |
| | high-humidity test @23° C. | | | | | | | | | |

*NA = Unmeasurable
Irgacure 184: 1-Hydroxycyclohexyl phenyl ketone (manufactured by Ciba Specialty Chemicals Co., Ltd.)
Lucirin TPO: 2,4,6-Trimethylbenzoyldiphenylphosphine oxide (manufactured by BASF)
Irgacure 819: Bis(2,4,6-trimethylbenzoyl)diphenylphosphine oxide (manufactured by Ciba Specialty Chemicals Co., Ltd.)
Irganox 1035: Thiodiethylenebis[3-(3,5-di-tert-butyl-4-hydroxyphenyl)propionate] (manufactured by Ciba Specialty Chemicals Co., Ltd.)
E1-1: PPG4000: polypropylene glycol with molecular weight of 4000 (manufactured by Asahi Glass Urethane Co., Ltd.)
E1-2: (Meth)acryloyl group-containing polypropylene glycol (molecular weight: 10000) obtained in Synthesis Example 3
E2-1: DC57: dimethylpolysiloxane-polyoxyalkylene copolymer (manufactured by Dow Corning Toray Silicone Co., Ltd.)
E2-2: (Meth)acryloyl group-containing Silicone compound (molecular weight: 1170) obtained in Synthesis Example 4
Particle 1: C302A (aluminum hydroxide, average particle size: 2 μm; manufactured by Sumitomo Chemical Co., Ltd.)
Particle 2: H42-S (aluminum hydroxide surface-treated with stearic acid, average particle size: 1.2 μm; manufactured by Showa Denko K.K.)
Particles 3: Ace 35 (calcium carbonate, average particle size: 1.0 μm; manufactured by Hayashi Kasei Co., Ltd.)
Particle 4: SX8742 (A)-09 (styrene-divinylbenzene copolymer, average particle size: 0.9 μm; manufactured by JSR Corporation)
Particle 5: H42-STV (aluminum hydroxide surface-treated with vinylsilane, average particle size: 1.2 μm; manufactured by Showa Denko K.K.)
Particle 6: KISUMA-5A (magnesium hydroxide surface-treated with fatty acid; manufactured by Kyowa Chemical Industry Co., Ltd.)
Particle 6: KISUMA-5P (magnesium hydroxide surface-treated with vinylsilane; manufactured by Kyowa Chemical Industry Co., Ltd.)
Particle 6: Calseeds P (calcium carbonate surface-treated with fatty acid; manufactured by Konoshima Chemical Co., Ltd.)

As is clear from Table 1, the cured product of the resin composition of the present invention exhibits excellent properties as an optical fiber coating material and exhibits excellent removability which is maintained after the temperature change and exposure to heat-moisture Therefore, the composition of the present invention is useful as an upjacket composition.

### BRIEF DESCRIPTION OF THE DRAWINGS

FIG. 1 shows a schematic diagram of a tensile tester.

FIG. 2 shows a schematic diagram of stress required for removing a coating.

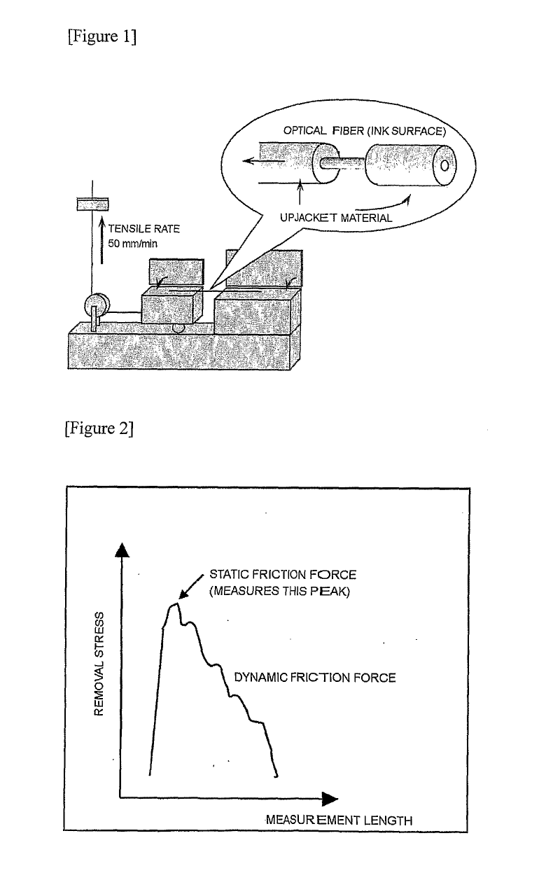

1. A radiation-curable liquid resin optical fiber upjacket composition, comprising:
(A) a urethane (meth)acrylate obtained by reacting a polyol, a polyisocyanate, and a hydroxyl group-containing (meth)acrylate;
(B) a monofunctional radiation-curable monomer;
(C) a polyfunctional radiation-curable monomer;
(D) 5 to 60 wt % of inorganic particles or polymer particles having an average particle size of 0.1 to 100 μm; and
(F) a photoinitiator;
wherein the weight percentage of said inorganic particles or polymer particles is 5 to 60 wt %, relative to the total weight of A, B, C and F.

2. The composition according to claim 1, further comprising:
(E) 1 to 20 wt % of a polyol or a silicone compound having an average molecular weight of 1000 or more, relative to the total weight of A, B, C and F.

3. The composition according to claim 1, further comprising:
(E1) 1 to 20 wt % of a polyol having an average molecular weight of 1000 or more, relative to the total weight of A, B, C and F; and
(E2) 1 to 20% of a silicone compound having an average molecular weight of 1000 or more, relative to the total weight of A, B, C and F.

4. The composition according to claim 1, wherein the component (D) is inorganic particles.

5. The composition according to claim 4, wherein the component (D) includes calcium carbonate or aluminum hydroxide.

6. The composition according to claim 1, further comprising a flame retardant G.

7. The composition according to claim 1, wherein said composition, when cured, has a Young modulus of about 100 MPa to about 600 MPa.

8. The composition according to claim 1, wherein said composition, when cured, has a cure shrinkage rate of no more than 5.5%.

9. The composition according to claim 1, wherein said composition, when cured, has a coefficient of linear expansion of no more than 1.3.

10. An optical fiber upjacket layer, comprising a cured product of the composition according to claim 1.

11. An upjacketed optical fiber, comprising the optical fiber upjacket layer according to claim 10.

12. A process of making an optical fiber upjacket layer comprising the step of curing the composition according to claim 1.

13. The use of the optical fiber upjacket layer according to claim 10 as an upjacket coating exhibits good removability as well as low cure shrinkage rate and coefficient of linear expansion.
